(19) United States
(12) Patent Application Publication
(10) Pub. No.: US 2004/0075934 A1
(43) Pub. Date: Apr. 22, 2004

(54) Apparatus and method for retracting an actuator

(76) Inventors: LeeLing Tan, Singapore (SG); Xiong Liu, Singapore (SG); KianKeong Ooi, Singapore (SG); James LaiKein Chang, Singapore (SG); Jimmy TzeMing Pang, Singapore (SG); ChoonKiat Lim, Singapore (SG)

Correspondence Address: Derek J. Berger, Seagate Technology LLC, Intellectual Property - COL2LGL, 389 Disc Drive, Longmont, CO, 80503, US

(21) Appl. No.: 10/606,034

(22) Filed: Jun. 25, 2003

Related U.S. Application Data
(60) Provisional application No. 60/419,939, filed on Oct. 21, 2002.

(51) Int. Cl. G11B 21/02

(52) U.S. Cl. 360/75

(57) ABSTRACT

A disc drive includes an information storage disc and an actuator assembly. A retraction voltage and a retraction time interval are calculated based on the location of a transducer over a surface of the information storage disc. The retraction voltage is applied for the retraction time interval such that the actuator assembly reaches the park position at a predetermined velocity. A brake time interval is calculated when the disc drive is operating in seek mode while power to the disc drive is interrupted. A brake is applied for the brake time interval to halt movement of the actuator assembly before the retraction voltage is applied. The values of retraction voltage, retraction time interval and brake time interval are continually updated in data tables. The values are retrieved when power to the disc drive is unexpectedly interrupted such that the actuator assembly reaches the park position at the predetermined velocity.

### FIELD OF THE INVENTION

This application relates generally to data storage devices and more particularly to actuator retraction when power to a disc drive or other such data storage device is interrupted.

### BACKGROUND OF THE INVENTION

Disc drives are data storage devices that store digital data in optical/magnetic form on a rotating storage medium. Modern magnetic disc drives comprise one or more information storage discs that are coated with a magnetizable medium and mounted on the hub of a spindle motor for rotation at a constant high speed. Information is stored on the discs in a plurality of concentric circular tracks typically by an array of transducers (“heads”) mounted to a radial actuator for movement of the heads in an arc across the surface of the discs. Each of the concentric tracks on each surface is generally divided into a plurality of separately addressable data sectors. The recording transducer, e.g. a head carrying a magnetoresistive read element and an inductive write element, is often referred to as a read/write head. The head is used to transfer data between a desired track and an external environment. During a write operation, data is written onto the disc track and during a read operation the head senses the data previously written on the disc track and transfers the information to a host computing system. The overall capacity of the disc drive to store information is dependent upon the disc drive recording density.

The transducers (heads) are mounted on gimbals and supported via flexures at the distal ends of a plurality of actuator arms that project radially outward from the actuator body. The actuator body pivots about a shaft mounted to the disc drive base plate at a position closely adjacent the outer edges of the discs. The pivot shaft is parallel with the axis of rotation of the spindle motor and the discs, so that the transducers move in planes parallel with the surfaces of the discs.

Such rotary actuators typically employ a voice coil motor to position the transducers with respect to the disc surfaces. The actuator voice coil motor includes a voice coil extending or projecting from the actuator body in a direction opposite the actuator arms and immersed in the magnetic field formed by one or two bipolar permanent magnets. When controlled direct current is passed through the coil, an electromagnetic field is set up which interacts with the magnetic field of the magnetic circuit to cause the coil to move in accordance with the well-known Lorentz relationship. As the coil moves, the actuator body pivots about the pivot shaft and the transducers move across the disc surfaces. The actuator thus allows the transducers to move back and forth in an arcuate fashion between an inner diameter and an outer diameter of the disc stack.

When the disc drive is de-energized, the transducers are automatically moved to a storage location or “park” location, either on the disc surfaces, or on a ramp off of the surfaces. The park location is typically adjacent and outside the inner or outer periphery of the data storage region of the disc surface and, if located on the disc, is typically called a landing zone. This landing zone typically does not contain any useable data as the transducer physically contacts the disc at rest. Consequently, any data stored in this area would likely be lost or compromised. In addition, the landing zone is typically roughened to minimize the stiction of the transducer against the disc surface.

Some disc drives utilize load/unload ramps to facilitate the removal of the transducer from the disc to a parked position adjacent the disc. The load/unload ramp in a disc drive is typically stationary and located at a peripheral portion of the information storage disc. Removal of the transducer from the disc is accomplished by the transducer/suspension assembly moving to the outer rim portion of the disc and then traversing up an inclined portion of the ramp to a park location on the load/unload ramp. As such, the transducers are physically “parked” off of the disc surfaces.

In this latter case, the transducers must be removed from the disc with precision to ensure proper disc drive operation. On one hand, the transducers will not be removed from the disc if the actuator is retracted and contacts the load/unload ramp at a speed below the lower end of a nominal velocity required to traverse the ramp. On the other hand, the transducers may become damaged if the actuator reaches the ramp at a speed outside the nominal velocity window. Thus, the retraction velocity of the actuator must be precisely controlled within a nominal velocity range. Against this backdrop the present invention has been developed.

### SUMMARY OF THE INVENTION

A disc drive in accordance with an embodiment of the present invention includes one or more information storage discs mounted on a spindle motor for rotating the discs, and an actuator assembly mounted on a base plate adjacent the discs. The information storage disc surfaces are preferably partitioned into zones. The actuator assembly typically carries a transducer for each surface and positions one transducer over each one of the surfaces of the information storage disc. The actuator assembly, in accordance with embodiments of the present invention, retracts the transducer(s) from the information storage disc, or discs, in response to a retraction voltage applied for a retraction time interval such that the actuator assembly reaches the park position at a predetermined velocity. The retraction voltage and retraction time interval are calculated based on the location of the transducer over the surface of the information storage disc.

The values of the retraction voltage and the retraction time interval are continually updated in a retraction data table. The retraction data table organizes the data based on the zone associated with the location of the transducer before the actuator assembly retracts the transducer. During most periods of drive operation, the drive is operating in a track following mode. Default values for the retraction voltage and the retraction time interval are retrieved from the retraction data table when power to the disc drive is unexpectedly interrupted. The retrieved values are applied such that the actuator assembly reaches the park position at the predetermined velocity.

The disc drive may, however, be operating in seek mode when power to the disc drive is interrupted. A brake time interval is calculated based on the velocity of the actuator assembly when power to the disc drive is interrupted. A brake is applied for the brake time interval to halt movement of the actuator assembly before the retraction voltage is applied as described above. Values of the brake time interval are continually updated in a brake data table. The brake data table organizes the data based on the zone associated with the location of the transducer when the brake is applied. A default value for the brake time interval is retrieved from the brake data table when power to the disc drive is unexpectedly interrupted. The brake is applied for the retrieved brake time interval before the retraction voltage is applied.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a flow diagram illustrating a process for preparing for actuator retraction when power to the disc drive is abnormally interrupted in accordance with a preferred embodiment of the present invention.

FIG. 3 is a flow diagram illustrating a process for retracting an actuator when power to the disc drive is abnormally interrupted in accordance with a preferred embodiment of the present invention.

### DETAILED DESCRIPTION

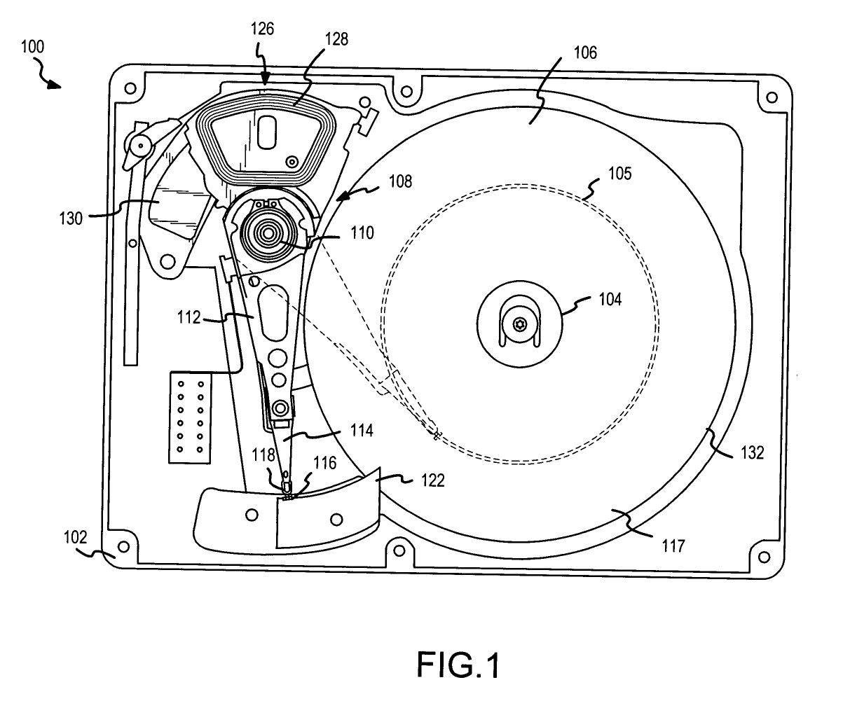

A disc drive 100 constructed in accordance with a preferred embodiment of the present invention is shown in FIG. 1. The disc drive 100 includes a base 102 to which various components of the disc drive 100 are mounted. A top cover (not shown) cooperates with the base 102 to form an internal, sealed environment for the disc drive in a conventional manner. The components include a spindle motor 104, which rotates one or more discs 106 at a constant high speed. Information is written to and read from tracks 105 on the discs 106 through the use of an actuator assembly 108, which rotates during a seek operation about a bearing shaft assembly 110 positioned adjacent the discs 106. The actuator assembly 108 includes a plurality of actuator arms 112 which extend towards the discs 106, with one or more flexures 114 extending from each of the actuator arms 112. Mounted at the distal end of each of the flexures 114 is a transducer 116 which is carried by a fluid bearing slider (not shown) enabling the transducer 116 to fly in close proximity above the corresponding surface 117 of the associated disc 106. Additionally, extending laterally from the distal end 118 of the flexure 114 is a lift tab 118 for engagement with a load/unload ramp 122.

During a seek operation, the track 105 position of the transducer 116 is controlled through the use of a voice coil motor (VCM) 126, which typically includes a coil 128 attached to the actuator assembly 108, as well as one or more permanent magnets 130 which establish a magnetic field in which the coil 128 is immersed. The controlled application of current to the coil 128 causes magnetic interaction between the permanent magnets 130 and the coil 128 so that the coil 128 moves in accordance with the well-known Lorentz relationship. As the coil 128 moves, the actuator assembly 108 pivots about the bearing shaft assembly 110, and the transducers 116 are caused to move across the surfaces of the discs 106.

The spindle motor 104 is typically de-energized when the disc drive 100 is not in use for extended periods of time or when a system reset is triggered. The transducers 116 are moved over the surfaces 117 of the discs 106 to the load/unload ramp 122 located at the outer diameter 132 of the information storage discs 106. The transducers 116 traverse onto the load/unload ramp 122 and are secured in position through the use of an actuator latch arrangement (not shown), which prevents inadvertent rotation of the actuator assembly 108 when the transducers 116 are parked.

The actuator assembly 108 retracts to park the transducers 116 on the load/unload ramp 122 in response to a constant retraction voltage applied to the VCM 126. The actuator assembly 108 is retracted at a speed within a predetermined nominal retraction velocity range when the retraction voltage is applied to the VCM 126 for a retraction time interval, i.e., the length of time that the retraction voltage is applied to the VCM 126. The values of the retraction voltage and the retraction time interval vary depending on the location of the transducer 116 over the surface 117 of the disc 106. Values for the retraction voltage and the retraction time interval are calculated each time the actuator assembly 108 is to be retracted under normal disc drive operating conditions. The retraction voltage and retraction time interval are calculated as follows.

When the disc drive is in track following mode immediately following the brake stage of a seek operation, the distance traveled is:

dₚₒᵢₙₜ=dᵢₙᵢₜᵢₐₗ±d_{btravel}+d₀

where dₚₒᵢₙₜ is defined as the final head location;

dᵢₙᵢₜᵢₐₗ is defined as the actuator assembly position upon power loss;

d_{btravel} is defined as the distance travelled while brake is applied; and

d₀ is defined as the distance between the load/unload ramp and the first data track.

When the disc drive is in track following mode the brake is not applied. Thus, d_{btravel}=0, then

dₚₒᵢₙₜ=dᵢₙᵢₜᵢₐₗ+d₀

The target angular velocity (ω_{target}) is determined by the following relationship.

$$\begin{matrix}{Accel}_{cvr} = \frac{{ω}_{target}^{2}}{2 * {d}_{point}} \\ where & eq ( 1 ) \\ {Accel}_{cvr} = \frac{Kt}{J} * {I}_{vcm} , \\ and & eq ( 2 ) \\ {I}_{vcm} = \frac{{V}_{cvr}}{{R}_{vcm}} & eq ( 3 )\end{matrix}$$

where J is the moment of inertia of the actuator;

Kₜ is the torque constant of the actuator assembly; and

I_{vcm} is the available current that can be drawn from the system, which is a constant.

Combining eq(2) & eq(3), the retraction voltage (V_{cvr}) is:

$${V}_{cvr} = \frac{{K}_{t}}{J * {R}_{vcm}} * {Accel}_{cvr} \qquad eq ( 4 )$$

further substituting eq(1) into eq(4), the retraction voltage becomes:

$${V}_{cvr} = \frac{{K}_{t}}{J} * \frac{\frac{{ω}_{target}^{2}}{2 * {d}_{point}}}{{R}_{vcm}} = \frac{{K}_{t}}{2 * J * {R}_{vcm}} * [ \frac{{ω}_{target}^{2}}{{d}_{point}} ] = \frac{{K}_{t}}{2 * J * {R}_{vcm}} * [ \frac{{ω}_{target}^{2}}{{d}_{point}} ]$$

or simplified as:

$${V}_{cvr} = {K}_{cvr} / {d}_{point} , \\ where {K}_{cvr} = \frac{{K}_{t} * {ω}_{target}^{2}}{2 * J * {R}_{vcm}} \qquad eq ( 5 )$$

The corresponding retraction time interval (t_{cvr}) applied for the retraction voltage scheme to achieve nominal speed at the load/unload ramp is,

$${t}_{cvr} = \frac{{ω}_{target}}{{Accel}_{cvr}} = \frac{{ω}_{target}}{\frac{{K}_{t}}{J} * {I}_{vcm}} = \frac{{ω}_{target} * {R}_{vcm}}{\frac{{K}_{t}}{J} * {V}_{cvr}} , \\ {t}_{cvr} = \frac{{K}_{time}}{{V}_{cvr}} \\ where {K}_{time} = \frac{{ω}_{target} * {R}_{vcm}}{\frac{{K}_{t}}{J}} \qquad eq ( 6 )$$

eq(5) and eq(6) are used to create the retraction data table.

The disc drive 100 may be in either seek or track following mode when the actuator assembly 108 is to be retracted upon an unexpected loss of power. The retraction voltage is applied immediately upon power loss to retract the actuator assembly 108 if the disc drive 100 is in track following mode. A brake (not shown) is first applied initially to halt movement of the actuator assembly 108 if a seek operation of the disc drive 100 is interrupted due to the power failure. Then, the retraction voltage is applied to retract the actuator assembly 108 after the brake is applied for a predetermined brake time interval.

The brake time interval, i.e., the length of time that the brake is applied to the actuator assembly 108, varies depending on the location of the transducers 116 over the surfaces 117 of the disc 106 and the velocity of the actuator assembly 108. The value for the brake time interval associated with different locations on the surface 117 of the disc 106 is calculated each time the brake is to be applied to the actuator assembly 108 under normal disc drive operating conditions. The brake time interval (t_{brake}) is calculated as shown below.

ω_{final}=ωᵢₙᵢₜᵢₐₗ+(Accel_{brake}*t_{brake})

where Accel_{brake} is the brake capability;

ωᵢₙᵢₜᵢₐₗ is the speed of the actuator upon power loss; and

ω_{final} is the speed of the actuator after the brake is applied.

ω_{final} is expected to be equal to zero.

Hence, the brake time interval is

$${t}_{brake} = \frac{{ω}_{initial}}{{Accel}_{brake}} \qquad eq ( 7 )$$

The brake capability (Accel_{brake}) uses the maximum current that can be drawn from the system (I_{vcm}).

$${Accel}_{brake} = \frac{{K}_{t}}{J} * {I}_{vcm} \qquad eq ( 8 )$$

Since Kₜ, J and I_{vcm} are constants, Accel_{brake} is fixed.

The brake time interval (t_{brake}) can be calculated as:

$${t}_{brake} = \frac{J}{{K}_{t} * {I}_{vcm}} * {ω}_{initial}$$

t_{brake} can be simplified as:

$${t}_{brake} = {K}_{brake} * {ω}_{initial} , \\ where {K}_{brake} = \frac{J}{{K}_{t} * {I}_{vcm}} \qquad eq ( 9 )$$

From eq(9), the brake time interval (t_{brake}) is proportional to ωᵢₙᵢₜᵢₐₗ, where ωᵢₙᵢₜᵢₐₗ is the actuator speed used to point to the brake data table to retrieve the brake time interval.

With the brake time interval (t_{brake}), the distance travelled during braking (d_{btravel}), can be calculated as:

$${d}_{btravel} = {ω}_{initial} * {t}_{brake} + \frac{1}{2} * {Accel}_{brake} * {t}_{brake}^{2} \qquad eq ( 10 )$$

substitute eq(7) & eq(8) into eq(10)

$$\begin{matrix}{d}_{btravel} = 1.5 * \frac{{ω}_{initial}^{2}}{{Accel}_{brake}} \\ {d}_{btravel} = ( \frac{1.5 J}{{K}_{t}^{*} {I}_{vcm}} ) * {ω}_{initial}^{2} \\ {d}_{btravel} = {K}_{const}^{*} * {ω}_{initial}^{2} , where \\ {K}_{const} = \frac{1.5 J}{{K}_{t}^{*} {I}_{vcm}}\end{matrix} \qquad eq ( 11 )$$

So the final head location (dₚₒᵢₙₜ) is given:

dₚₒᵢₙₜ=dᵢₙᵢₜᵢₐₗ±d_{btravel}+d₀ eq(12)

It is important to note that dₚₒᵢₙₜ will act as a pointer to point to the retraction data table to retrieve a suitable retraction voltage and retraction time interval.

In one embodiment of the invention, the surface 117 of the disc 106 is partitioned into eight concentric zones. The retraction data table includes values for retraction voltage and retraction time interval corresponding to each zone. The retraction data table is updated each time a new value is calculated for the retraction voltage and the retraction time interval. Likewise, the brake data table includes values for the brake time interval corresponding to each zone. The brake data table is also updated each time a new value is calculated for the brake time interval. The data tables are continually updated during normal operation of the disc drive 100. The data tables are updated by a serial port command from a microprocessor to a control circuit of the spindle motor 104 and the VCM 126.

The retraction voltage, retraction time interval and brake time interval are calculated from values of the transducer 116 location and the actuator assembly 108 velocity. Neither of these parameters is available when power to the disc drive 100 is unexpectedly interrupted outside normal disc drive operation. For example, power to the disc drive may be suddenly interrupted due to the removal of a plug of a computer from an electrical power outlet or local power outage caused by an electrical storm. Updating the data tables ensures that default values for retraction voltage, retraction time interval and brake time interval are available to retract the actuator assembly 108 when power to the disc drive 100 is unexpectedly interrupted. The appropriate values for retraction voltage, retraction time interval and brake time interval corresponding to the zone location of the transducers 116 when power to the disc drive 100 is unexpectedly interrupted can be retrieved from the data tables to retract the actuator assembly 108 at a velocity within a predetermined nominal range.

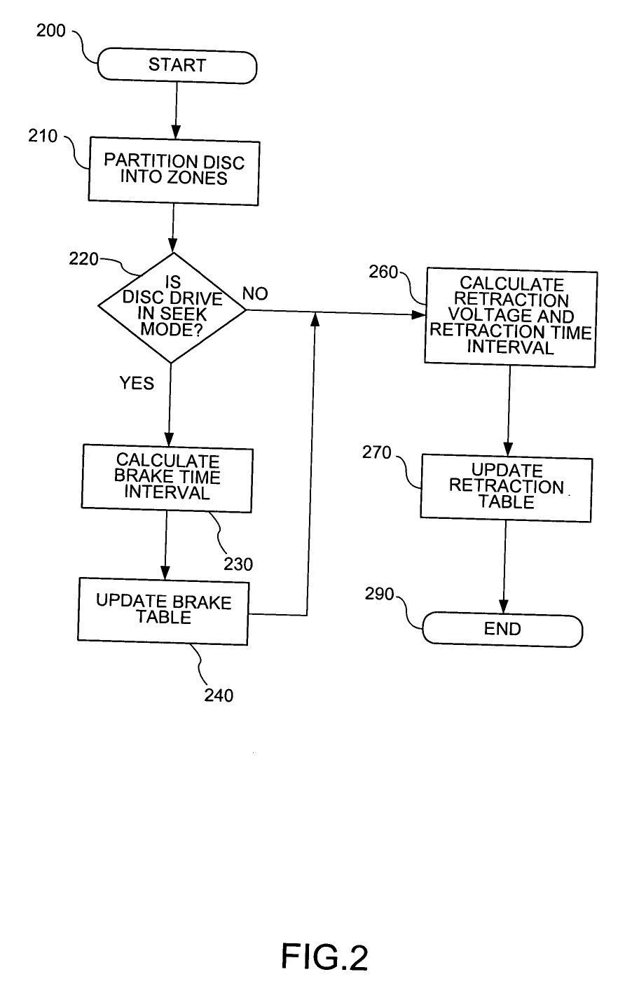

A process for preparing for actuator assembly retraction when power to the disc drive 100 is abnormally interrupted in accordance with one preferred embodiment of the present invention is shown in FIG. 2. The process begins in Operation 200. Process control then transfers to Operation 210. Operation 210 is bypassed if the information storage disc 106 is partitioned into a number of zones. If the disc 106 is not yet partitioned, the information storage disc 106 is partitioned into a number of zones. Process control then transfers to Query Operation 220. In Query Operation 220 the current operational mode of the actuator assembly 108 is determined, i.e., whether the actuator assembly 108 is in a seek mode or a track following mode. Process control transfers to Operation 260 if the actuator assembly 108 is in track following mode. Process control transfers to Operation 230 if the actuator assembly 108 is in seek mode.

If the actuator assembly 108 is in seek mode, in Operation 230 the brake time interval is calculated based on the actuator assembly velocity. Process control then transfers to Operation 240. In Operation 240 the brake data table is updated with the calculated value for the brake time interval. Process control then transfers to Operation 260.

In Operation 260 the retraction voltage and a retraction time interval are calculated based on the zone location of the transducer 116 over the surface 117 of the information storage disc 106. Process control then transfers to Operation 270. In Operation 270 the retraction data table is updated with the calculated values for the retraction voltage and retraction time interval. Process control ends in Operation 290.

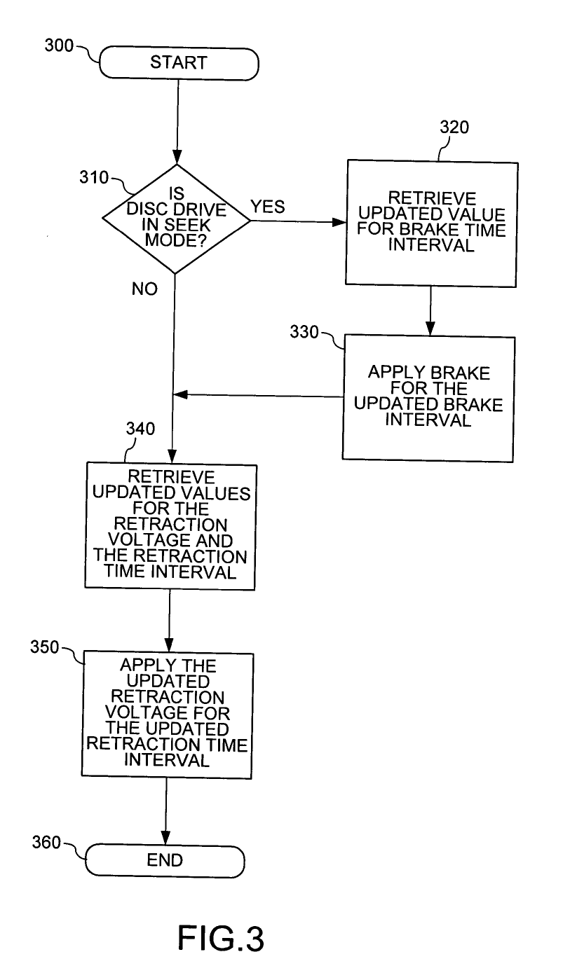

An exemplary process in accordance with the present invention for retracting an actuator assembly 108 when power in the disc drive 100 is unexpectedly interrupted is shown in FIG. 3. The process begins in Operation 300. Here, registers are initialized. Process control then transfers to Query Operation 310. In Query Operation 310 the operational mode of the actuator assembly 108 is ascertained, i.e., track following mode or seek mode. Process control transfers to Operation 340 if the actuator assembly 108 is in track following mode. Process control transfers to Operation 320 if the actuator assembly 108 is in seek mode.

In Operation 320, if the actuator assembly 108 is in seek mode the updated value for the brake time interval is retrieved from the brake data table based on the zone location of the transducer 116. Process control then transfers to Operation 330. In Operation 330 the brake is applied for the updated brake time interval to halt movement of the actuator assembly 108. Process control then transfers to Operation 340.

In Operation 340 the updated values for the retraction voltage and retraction time interval are retrieved from the retraction data table based on the zone location of the transducer 116. Process control then transfers to Operation 350. In Operation 350 the updated value of the retraction voltage is applied for the updated retraction time interval such that the actuator assembly 108 contacts the load/unload ramp 122 at a velocity within a predetermined nominal range. Process control ends in Operation 360.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the nominal range of values may be other than as described above. Numerous other changes may be made which will readily suggest themselves to those skilled in the art and which are encompassed in the spirit of the invention disclosed and as defined in the appended claims.

What is claimed is:

1. A disc drive comprising:
an information storage disc rotatably mounted on a spin motor and having a surface partitioned into a plurality of zones;
an actuator assembly for positioning a transducer over the surface of the information storage disc, the actuator assembly retracting the transducer from a data portion of the information storage disc in response to a retraction voltage applied for a retraction time interval, the retraction voltage and retraction time interval being calculated based on the location of the transducer on the surface of the information storage disc;
a retraction data table that is arranged to store values for the retraction voltage and the retraction time interval corresponding to the zone associated with the location of the transducer; and
a park position for supporting the transducer off of the data portion of the information storage disc when the transducer is retracted, the actuator assembly reaching the park position at a velocity within a predetermined range when the retraction voltage is applied for the retraction time interval;
wherein predetermined default values for the retraction voltage and the retraction time interval based on the zone location of the transducer when power to the disc drive is interrupted are retrieved from the retraction data table such that the actuator assembly reaches the park position at a velocity within the predetermined range.

2. The disc drive of claim 1, wherein the park position is adjacent a peripheral portion of the information storage disc.

3. The disc drive of claim 1, wherein the park position is a load/unload ramp.

4. The disc drive of claim 1, wherein the retraction voltage is constant.

5. The disc drive of claim 1, wherein the predetermined default values for the retraction voltage and the retraction time interval based on the zone location of the transducer are retrieved from the retraction data table when power to the disc drive is unexpectedly interrupted.

6. The disc drive of claim 1, wherein the values of the retraction voltage and the retraction time interval are updated in the retraction data table by a serial port command.

7. The disc drive of claim 1, further comprising a brake that is arranged to be applied to the actuator assembly for a brake time interval when the disc drive is in seek mode while power to the disc drive is interrupted to halt movement of the actuator assembly.

8. A disc drive comprising:
an information storage disc rotatably mounted on a spin motor and having a surface partitioned into a plurality of zones;
an actuator assembly for positioning a transducer over the surface of the information storage disc;
a brake that is arranged to be applied to the actuator assembly for a brake time interval when the disc drive is in seek mode while power to the disc drive is interrupted to halt movement of the actuator assembly; and
a brake data table that is arranged to store values for the brake time interval corresponding to the zone associated with a velocity of the actuator assembly when power to the disc drive is interrupted;
wherein a predetermined default value for the brake time interval based on the zone location of the transducer when power to the disc drive is interrupted is retrieved from the brake data table.

9. The disc drive of claim 8, wherein the value of the brake time interval is updated in the brake data table such that the default value for the brake time interval is available when power to the disc drive is unexpectedly interrupted.

10. The disc drive of claim 8, wherein the brake is applied before the actuator assembly is retracted.

11. The disc drive of claim 8, wherein the brake time interval is calculated based on the velocity of the actuator assembly when power to the disc drive is interrupted.

12. The disc drive of claim 8, wherein the zones are concentric.

13. In a disc drive having an information storage disc rotatably mounted on a spin motor and an actuator assembly adjacent the information storage disc for positioning a transducer over a surface of the information storage disc, a method of retracting an actuator assembly to a park position for supporting the transducer off of a data portion of the information storage disc, the method comprising steps of:
partitioning the information storage disc into a plurality of zones;
calculating a retraction voltage and a retraction time interval based on the location of the transducer on the surface of the information storage disc;
updating a retraction data table with the calculated values for the retraction voltage and retraction time interval;
retrieving updated values for the retraction voltage and retraction time interval from the retraction data table based on the zone location of the transducer when power to the disc drive is interrupted; and
applying the updated retraction voltage for the updated retraction time interval such that the actuator assembly reaches the park position at a velocity within the predetermined range when power to the disc drive is interrupted.

14. The method according to claim 13, wherein the calculating step further comprises the step of:
calculating a brake time interval based on a velocity of the actuator assembly when the disc drive is in seek mode while power to the disc drive is interrupted.

15. The method according to claim 14, wherein the updating step further comprises the step of:
updating a brake data table with the calculated value for the brake time interval.

16. The method according to claim 15, wherein the retrieving step further comprises the steps of:
retrieving the updated value for the brake time interval from the brake data table based on the zone location of the transducer when power to the disc drive is interrupted; and
applying the brake for the updated brake time interval to halt the actuator assembly before applying the updated retraction voltage when power to the disc drive is interrupted.

17. A disc drive having an information storage disc partitioned into a plurality of zones and a park position, comprising:
an actuator assembly adjacent the information storage disc for positioning a transducer over a surface of the information storage disc; and
a means for ensuring that the actuator assembly reaches the park position at a velocity within a predetermined range when power to the disc drive is interrupted.

18. The disc drive of claim 17, wherein the means for ensuring comprises a retraction means for retrieving values of retraction voltage and retraction time interval based on the zone location of the transducer above a surface of the information storage disc, and for applying the retraction voltage for the retraction time interval to retract the actuator assembly.

19. The disc drive of claim 18, wherein the retraction means is a retraction data table.

20. The disc drive of claim 17, wherein the means for ensuring comprises a brake means for retrieving values of brake time interval based on the zone location of the transducer above a surface of the information storage disc, and for applying the brake for the brake time interval to halt the actuator assembly.

21. The disc drive of claim 20, wherein the brake means comprises a brake data table.
